(19) United States
(12) Patent Application Publication
(10) Pub. No.: US 2010/0245985 A1
(43) Pub. Date: Sep. 30, 2010

(54) Wavelength converting devices

(75) Inventor: Takashi Yoshino, Ama-Gun (JP)

Correspondence Address: BURR & BROWN, PO BOX 7068, SYRACUSE, NY, 13261-7068, US

(73) Assignee: NGK Insulators, Ltd, Nagoya-City (JP)

(21) Appl. No.: 12/661,299

(22) Filed: Mar. 15, 2010

(30) Foreign Application Priority Data
Mar. 24, 2009 (JP) 2009-071647

(51) Int. Cl. G02F 1/355

(52) U.S. Cl. 359/326

(57) ABSTRACT

A wavelength converting substrate 1 is made of a Z plate of a ferroelectric single crystal, and includes a periodic domain inversion structure 2 formed therein, an incident face 1c of a fundamental wave 15, an emitting face 1d of a wavelength converted light, a +Z face 1a and a −Z face 1b. A wavelength converting device 20A has the substrate 1, a first conductive layer 6A formed to contact the +Z face 1a of the substrate 1, and a second conductive layer 6B formed to contact the −Z face 1b of the substrate 1.

This application claims the benefit of Japanese Patent Application P2009-71647 filed on Mar. 24, 2009, the entirety of which is incorporated by reference.

### TECHNICAL FIELD

The present invention relates to a wavelength converting device using a periodic domain inversion structure.

### BACKGROUND ART

Nonlinear optical crystal such as lithium niobate or lithium tantalate single crystal has a high secondary nonlinear optical constant. When a periodic domain polarization inversion structure is formed in the above crystals, a second-harmonic-generation (SHG) device of a quasi-phase-matched (QPM) system can be realized. Further, when a waveguide is formed within this periodic domain inversion structure, the high-efficiency SHG device can be realized and applied to a wide range of applications such as communication, medical science, photochemistry, various optical measurements.

The assignee filed Japanese Patent publication No. 2005-55528A and disclosed the invention of inputting light emitted from a Broad area semiconductor laser oscillating device of Fabri-Perot type into a slab type optical waveguide made of a non-linear optical crystal as a fundamental wave, so that blue laser light is output from the slab type optical waveguide.

The slab type optical waveguide mentioned herein is produced by polishing and thinning a Z-plate of a non-linear optical single crystal such as potassium lithium niobate.

According to “Mitsubishi Densen Kogyo Jiho” No. 100, pages 35 to 40, “Development of High Efficiency Waveguided Green SHG Device”, a periodic domain inversion structure is formed in a Z-plate of MgO-doped lithium niobate single crystal. A fundamental wave of 1064 nm is incident into the Z-plate to oscillate second harmonic wave.

According to “FUJI FILM RESEARCH & DEVELOPMENT” No. 48, 2003, pages 22 to 27, “Development of Periodically Poled Wavelength Converter and the Application”, a periodic domain inversion structure is formed in an MgO-doped lithium niobate single crystal by corona charging, so that blue second harmonic wave is oscillated.

### DISCLOSURE OF THE INVENTION

As shown in FIGS. 1(a) to 1(c), a bulk type periodic domain inversion device 10 is formed by applying a pulse voltage between a +Z face 1a and −Z face 1b of a Z plate 1 to form polarization inversion parts 4 at a predetermined period. 3 represents domain non-inversion parts.

Fundamental wave 15 is made incident into an incident face 1c and its wavelength is converted within the periodic domain inversion structure 2, so that the wavelength converted light is emitted from an emitting face 1d. It is preferable that the domain inversion parts 4 penetrate through the Z plate 1 from the +Z face to −Z face.

In the case of such bulk type periodic domain inversion device, however, during thermal treatment in the production process and thermal cycle test after the production, discharge is observed due to piezoelectric effect. The shock of the discharge results in crack formation so that the wavelength conversion efficiency may be lowered.

For example, it is necessary to subject the end face of the device to optical polishing and then form an anti-reflection film on the end face. In the process, a plurality of the devices are stacked and held, and the end faces of the devices are polished together at the same time. For the polishing, the devices are adhered onto a jig by heating a wax or the like, resulting in cracks due to pyroelectricity.

The inventors studied the cause of the phenomenon and found the followings. That is, after a periodic domain inversion structure as shown in FIG. 1 is formed by electric field poling, non-inverted parts 12A and 12B as shown in FIG. 3 are generated on the +Z face 1a and −Z face 1b of the substrate. For example, as shown in FIG. 5 of a photograph showing the +Z face, the inversion defects (periodic inversion defects) are left and observed on the surface in a part of the +Z face as whitish defects.

The inventors studied further the domain inversion defects. FIG. 6 shows the region without the inversion defects. The upper side and lower side of the substrate shown in FIG. 6 are +Z face and −Z face, respectively. It is proved that the domain inversion parts penetrate the substrate from the +Z face (upper face) to the −Z face (lower face) to reach the respective surfaces. In this case, the inversion defects are not observed in the surface regions.

FIG. 7 shows the cross section of the inversion defects of FIG. 5. The upper side and lower side of the substrate are +Z face and −Z faces, respectively. The domain inversion parts are formed inside of the substrate and the domain inversion defects are observed at some regions inside of the substrate. The inversion defects inside of the substrate, however, does not considerably interfere with the wavelength conversion. On the contrary, the domain inversion defects are observed near the +z face (upper face) and −Z face (lower face) of the substrate, so that the inversion region does not reach the surfaces of the substrate. As a result, as shown in FIG. 5, the inversion defects are observed in the surface region.

It has been speculated that such inversion defects left in the surface region would not considerably affect the wavelength conversion. However, in the actual process, during the above described heating and cooling in the production and the thermal cycles after the production, loads are accumulated in the inversion defects in the surface region of the substrate, resulting in the abnormal discharge. It is thus proved that the discharge traces are generated on the surface as shown in FIG. 8 to result in cracks in the substrate.

An object of the present invention is to provide a novel wavelength conversion device composed of a Z plate of a ferroelectric single crystal with a periodic domain inversion structure formed therein, so that cracks in the Z plate due to the abnormal discharge generated during the heating and cooling of the device to prevent the reduction of the wavelength conversion efficiency.

A wavelength converting device of the present invention comprises;

a wavelength converting substrate comprising a Z plate of a ferroelectric single crystal, a periodic domain inversion structure formed therein, an incident face of a fundamental wave, an emitting face of a wavelength converted light, a +Z face and −Z face;

a first conductive layer formed to contact the +Z face of the wavelength converting substrate; and

a second conductive layer formed to contact the −Z face of the wavelength converting substrate.

According to the present invention, the conductive layers are formed on the +Z face and −Z face of the Z plate with the periodic domain inversion structure formed therein, respectively. Even when the inversion defects are generated in the surface regions of the +Z face and −Z face, it is possible to prevent cracks due to the abnormal discharge starting from the inversion defects during the subsequent heating and cooling. The reduction of the conversion efficiency can be thereby prevented. That is, even when the inversion defects are present in the surface regions, it is proved that the reduction of the conversion efficiency due to the defects itself are not observed.

### BRIEF DESCRIPTION OF THE DRAWINGS

FIG. 1(a) is a front view schematically showing a bulk type wavelength converting device 10 using a Z plate, FIG. 1(b) is a plan view schematically showing the device 10, and FIG. 1 (c) is an enlarged view showing polarization inversion parts 4 and non-inversion parts 3.

FIG. 2 is a front view schematically showing a wavelength converting device 20A according to an embodiment of the present invention.

FIG. 3(a) is a front view schematically showing a wavelength converting device 20B according to another embodiment of the present invention, and FIG. 2(b) is a front view of the device 20B.

FIG. 4 is a front view schematically showing a device 20C having a wavelength converting substrate adhered with a supporting body 9.

FIG. 5 is a photograph showing good domain inversion parts and inversion defects observed on +Z face of a wavelength converting substrate.

FIG. 6 is a photograph showing a periodic domain inversion structure from +Z face to −Z face of a wavelength converting substrate, in which domain inversion parts penetrate from the +Z face to −Z face.

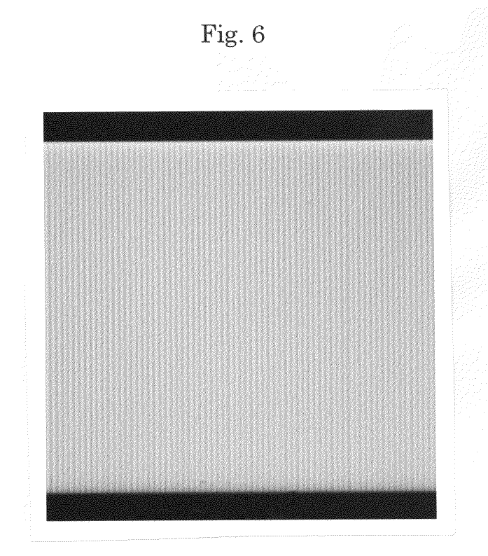

FIG. 7 is a photograph showing a periodic domain inversion structure from +Z face to −Z face of a wavelength converting substrate, in which inversion defects are observed near the +Z face and −Z face.

FIG. 8 is a photograph showing cracks observed in the surface region of the substrate due to abnormal discharge after the wavelength converting device is subjected to heating and cooling.

### MODES FOR CARRYING OUT THE INVENTION

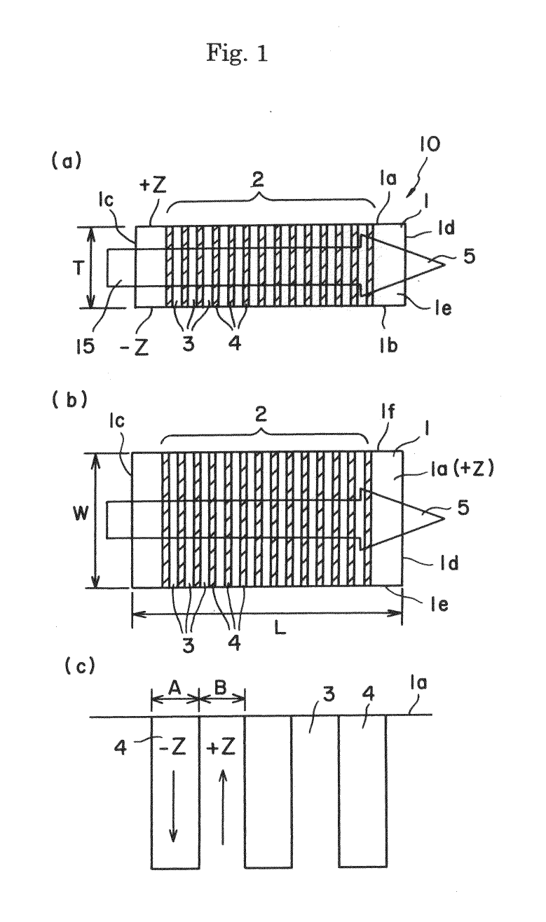

As shown in FIGS. 1 (a) to 1(c), a bulk type periodic domain inversion device 10 is made of a Z plate 1 typically having a thickness “T” of 0.3 mm or more for simplifying the alignment of the optical axis. A pulse voltage is applied between the +Z face 1a and −Z face 1b to form a period domain inversion structure 4 having a predetermined period. A Z plate means a plate having a direction of polarization extending between its upper face and lower face and substantially perpendicular to the upper and lower faces. 3 represents domain non-inversion parts, and 1e and 1f represent side faces.

Fundamental wave 15 is incident into an incident face 1c and then subjected to wavelength conversion in a periodic domain inversion structure 2 to emit wavelength converted light from an emitting face 1d as an arrow 5. Ideally, it is preferred that the domain inversion parts 4 penetrate through the substrate from +Z face to −Z face. Further, the ratio (duty ratio) of the width “A” of the domain inversion parts 4 to the width “B” of the non-inversion parts 3 is preferably be 1:1 through the whole thickness of the substrate, on the viewpoint of the conversion efficiency, as shown in FIG. 1(c).

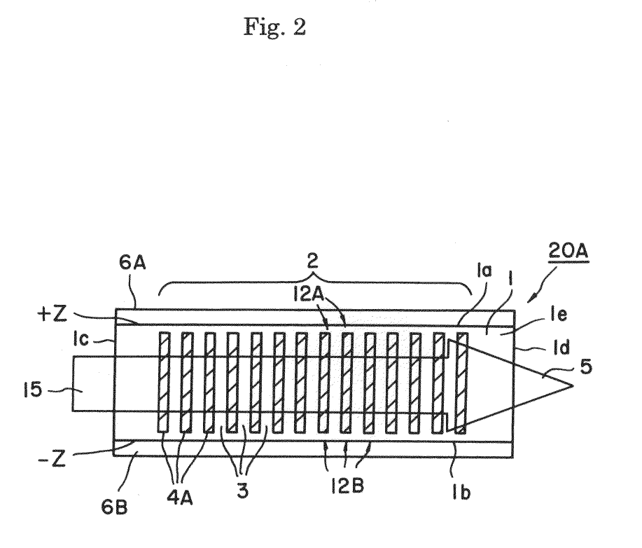

In actual wavelength converting substrates, however, for example as shown in FIG. 2, the domain inversion parts 4A are formed inside of the substrate and does not reach the +Z face 1a and −Z face 1b. Therefore, the inversion defects 12A and 12B are generated near the +Z face 1a and −Z face 1b, respectively. During the heating and cooling of the device, abnormal discharge occurs from such inversion defects 12A and 12B near the surfaces to result in cracks in the substrate.

Therefore, according to the present invention, a conductive film 6A is formed on the +Z face 1a of the wavelength conversion substrate 1 and a conductive film 6b is formed on the −Z face 1b. The conductive films 6A and 6B contacts the +Z face and −Z face, respectively. It is found that, if an insulating film is provide between the conductive film and the +Z face or the −Z face, the above described effect of preventing the cracks is not obtained.

It is further proved that, if the conductive film on the +Z face and the conductive film on the −Z face are not electrically connected to each other, the above described effect of preventing the cracks can be obtained. Therefore, according to the present invention, it is preferred that the conductive films are not electrically connected to each other.

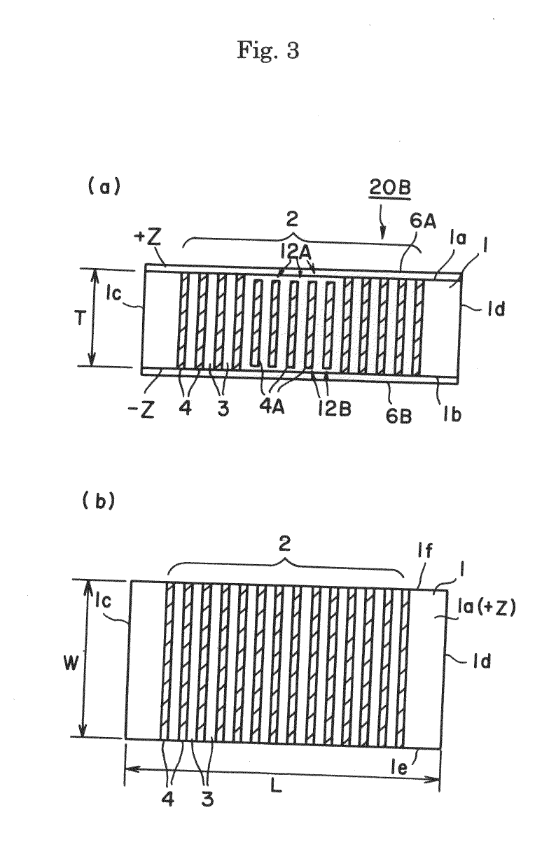

In a device 20B shown in FIGS. 3(a) and 3(b), the domain inversion parts 4 are formed in the Z plate 1 made of a ferroelectric single crystal at a predetermined period and extends from the +Z face 1a to the −Z face 1b. The non-inversion parts 3 are left between the adjacent inversion parts 4, respectively. The periodic domain inversion structure 2 is formed by alternately forming the domain inversion parts 4 and non-inversion parts 3 at a predetermined period.

According to the example of FIG. 3, in a part of the domain inversion parts 4A, the inversion defects 12a and 12b are observed near the +Z face 1a and −Z face 1b, respectively. Therefore, according to the present invention, a conductive film 6A is formed on the +Z face 1a of the wavelength converting substrate 1 and a conductive film 6b is formed on the −Z face 1b.

In the case that the wavelength converting substrate 1 made of a ferroelectricc single crystal is composed of an X plate or Y plate and not of a Z plate, during the heating and cooling, the abnormal discharge from the inversion defects near the surface does not occur. Therefore, the above described propagation loss in the optical waveguide does not occur in the first place. That is, the present invention is based on the discovery of the above unique problem characteristic in the above described particular structure, and thus inventive.

According to the present invention, the thickness “T” of the wavelength conversion substrate 1 (refer to FIGS. 1 and 3) may preferably be 50 μm or more. By increasing the thickness “T” to 100 μm or more, the fundamental wave can be easily made incident into the optical waveguide, so that the connection efficiency of the fundamental wave can be improved. On the viewpoint, the thickness “T” of the wavelength conversion substrate 1 may more preferably be 300 μm or more.

Further, the thickness “T” of the wavelength converting substrate may preferably be 1000 μm or less so that the energy density of the guided light and the conversion efficiency can be improved. On the viewpoint, the thickness of the wavelength converting substrate may more preferably be 500 μm or less.

The ferroelectric single crystal for forming the wavelength conversion substrate is not limited, as far as it is capable of modulating light. Lithium niobate, lithium tantalate, a solid solution of lithium niobate-lithium tantalate, potassium lithium niobate, KTP, GaAs, quartz, K₃Li₂Nb₅O₁₅ or La₃Ga₅SiO₁₄ can may be exemplified.

In the ferroelectric single crystal, for further improving the resistance against the optical damage of the optical waveguide, one or more metal elements selected from the group consisting of magnesium (Mg), zinc (Zn), scandium (Sc) and Indium (In) may be contained in the single crystal, and magnesium is most preferred. The ferroelectric single crystal may contain a rare earth element as a dopant. Such rare earth element functions as an additive for laser oscillation. Such rare earth element may preferably be Nd, Er, Tm, Ho, Dy or Pr.

The material of the conductive film includes a metal and a conductive paste. Specifically, Al, Ti, Ta, Cu, Ag based paste and In based paste are preferred.

Although the thickness of the conductive film is not particularly limited, it may preferably be 0.05 μm or more, and more preferably be 0.1 μm or more, on the viewpoint of the present invention. Further, for preventing the optical absorption by the conductive film, the thickness of the conductive film may preferably be 5 μm or less.

It is preferred that the conductive film covers 90 percent or more, and more preferably be the whole, of each of the +Z face and −Z face.

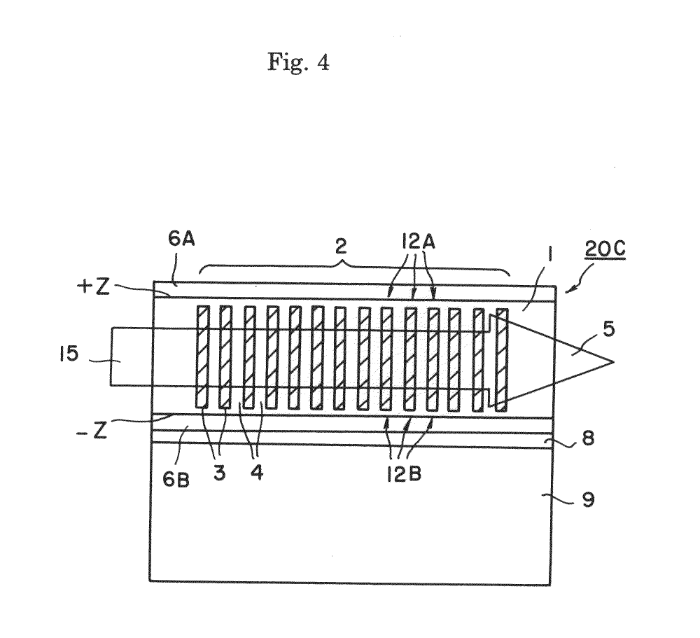

Further, in a preferred embodiment, as shown in FIG. 4, the above described device may be adhered with a supporting body 9 through an adhesive layer 8.

The difference of thermal expansion coefficients of the materials of the supporting body and the wavelength converting substrate may preferably be 10 percent or less of that of the wavelength converting substrate. Specifically, lithium niobate, lithium tantalate, a solid solution of lithium niobate-lithium tantalate, potassium lithium niobate, KTP, GaAs, quartz, K₃Li₂Nb₅O₁₅ or La₃Ga₅SiO₁₄ can may be exemplified.

The adhesive for adhering the wavelength conversion substrate to the supporting body may be an inorganic adhesive, an organic adhesive or a combination of inorganic and organic adhesives.

Although specific examples of the organic adhesive is not particularly limited, it may be epoxy resin adhesive, acrylic resin adhesive, a thermosetting resin adhesive, an ultraviolet curable resin adhesive, or “Alon ceramics C” (trade name: Supplied by Toa Gosei Co. Ltd.,) having a thermal expansion coefficient (thermal expansion coefficient of 13×10⁻⁶/K) relatively close to that of a material having an electro-optic effect, such as lithium niobate.

Further, the inorganic adhesive preferably has a low dielectric constant and an adhesive temperature (working temperature) of about 600° C. or lower. Further, it is preferable that a sufficiently high adhesive strength can be obtained during the processing. Specifically, it is preferably a glass having a composition of one or more of silicon oxide, lead oxide, aluminum oxide, magnesium oxide, calcium oxide, boron oxide or the like. Further, another inorganic adhesive includes tantalum pentoxide, titanium oxide, niobium pentoxide or zinc oxide, for example.

A method of forming the inorganic adhesive layer is not particularly limited and includes sputtering, vapor deposition, spin coating, or sol-gel method. Further, a sheet of an adhesive may be interposed between the wavelength converting substrate and the supporting body to join them. Preferably, a sheet made of a thermosetting, photocuring or photothickening resin adhesive is interposed between the wavelength converting substrate and the supporting body, and the sheet is then cured. For such a sheet, a resin film having a thickness of 10 μm or less is appropriate.

In the production, for example, the conductive films are formed on the wavelength converting substrate 1, and a plurality of the devices are laminated and held as an integrated body. The laminated body is then fixed on a surface plate with a wax or the like, and the end faces are subjected together to optical polishing at the same time.

### EXAMPLES

### Comparative Example 1

The second harmonic wave oscillating device 10 shown in FIG. 1 was manufactured.

Specifically, the periodic domain inversion structure 2 having a period of 6.9 μm was formed on an MgO 5% doped lithium niobate Z plate 1 of a thickness “T” of 0.5 mm by electric field poling process. The thus obtained wavelength converting substrate 1 was cut into bars each having a length “L” of 20 mm and a width “W” of 3.0 mm with a dicer.

The thus obtained five devices 10 after the cutting were laminated and fixed on a jig with a thermosetting wax. The heating temperature at the step was 90° C. Thereafter, the end faces of the devices were polished together at the same time and the devices were heated to 90° C. again to soften the fixing wax to pick up the devices 10 from the jig.

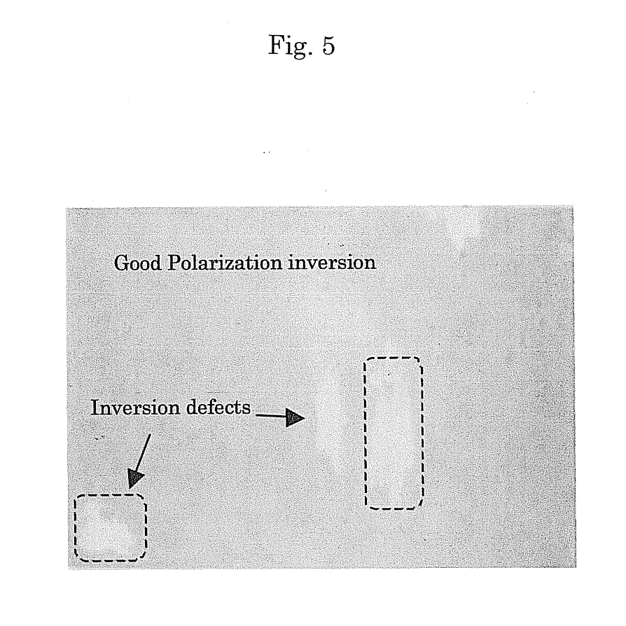

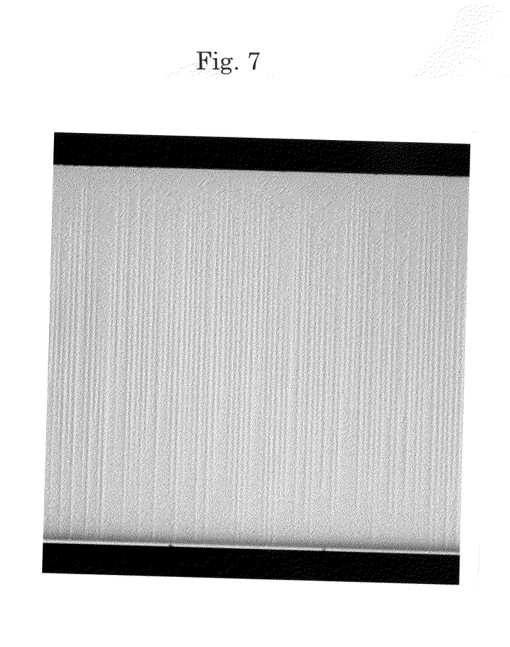

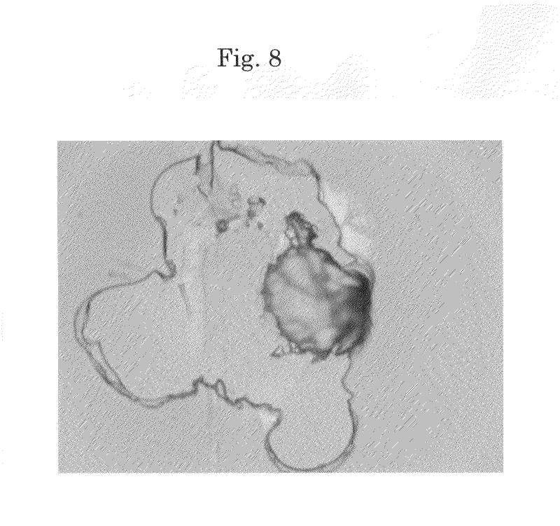

Thereafter, the +Z face 1a and −Z face 1b of the substrate were observed to prove that several discharge traces having a diameter of about 100 microns were observed on the both faces as shown in FIG. 8. Further, near the discharge traces, the inversion defects were observed as shown in FIGS. 5 and 7.

After the cutting of the devices, laser beam having a wavelength of 1064 nm at a power of 1 W was made incident on the end face to perform the quasi-phase-matching, so that an output power of 3 mW was obtained at 532 nm. The end face of the device was observed to prove that cracks each having a depth of about 200 μm were generated around the discharge traces. The device was subjected to temperature cycle test and the performance was measured again after the 200 cycles to prove that the output power at 532 nm was lowered to 1 mW.

The device was polished from the surface to a thickness of 250 μm and the state of the inversion was observed by etching. It was thus proved that the period of domain inversion was disordered in areas of about 30 percent of the whole area.

### Example 1

The second harmonic wave oscillating device 20B shown in FIG. 3 was manufactured.

Specifically, the periodic domain inversion structure 2 having a period of 6.9 μm was formed on an MgO 5% doped lithium niobate Z plate 1 of a thickness “T” of 0.5 mm. Aluminum films 6A and 6B each having a thickness of 300 nm were formed on the +Z face and −Z face, respectively, by sputtering. The thus obtained wavelength converting substrate 1 was cut into bars each having a length “L” of 20 mm and a width “W” of 3.0 mm with a dicer.

The thus obtained five devices 10 after the cutting were laminated and fixed on a jig with a thermosetting wax. The heating temperature at the step was 90° C. Thereafter, the end faces of the devices were polished together at the same time and the devices were heated to 90° C. again to soften the fixing wax to pick up the devices 10 from the jig. The bars were washed and anti-reflection films for 1064 nm and 532 nm were coated on the emitting face.

After the cutting of the bar to devices each having a width “W” of 2 mm, Nd doped YAG laser beam having a wavelength of 1064 nm was made incident on the end face. The temperature of the device was adjusted to perform the quasi-phase-matching. It was thus proved that an laser output power of 10 mW was obtained at an incident optical power of 1 W at 532 nm. The device was subjected to 500 temperature cycles between −40° C. to +80° C., and after that, abnormal performance was not observed.

Although the inversion defects as shown in FIGS. 5 and 7 were observed on the surface of the device, the discharge trace as shown in FIG. 8 was not observed.

```
  1 Wavelength converting substrate
  1a +Zface
  1b −Zface
  1c Incident face
  1d Emitting face
  2 Periodic domain inversion structure
  3 Non-inversion part
  4 Domain inversion part
  5 Wavelength converted light
  6A, 6B Conductive film
10, 20A, 20B Wavelength converting device
12A, 12B Inversion defect
15 Fundamental wave
```

1. A wavelength converting device comprising:
a wavelength converting substrate comprising a Z plate of a ferroelectric single crystal, a periodic domain inversion structure formed in the substrate, an incident face of a fundamental wave, an emitting face of a wavelength converted light, a +Z face and a −Z face;
a first conductive layer formed to contact the +Z face of the wavelength converting substrate; and
a second conductive layer formed to contact the −Z face of the wavelength converting substrate.

2. The device of claim 1, wherein the first and second conductive films are not electrically connected with each other.

3. The wavelength converting device of claim 1, further comprising:
a supporting body; and
an adhesive layer adhering the supporting body to the first conductive layer or the second conductive layer.
